(19) United States
(12) Patent Application Publication
(10) Pub. No.: US 2025/0270136 A1
(43) Pub. Date: Aug. 28, 2025

(54) CARBON NANOTUBE FLY ASH COMPOSITE MATERIAL AND PREPARATION METHOD AND USE THEREOF

(71) Applicants: China Energy Science and Technology Research Institute Co., Ltd., Nanjing City (CN); Southeast University, Nanjing (CN)

(72) Inventors: Ke ZHUANG, Nanjing (CN); Yun XU, Nanjing (CN); Jingming CAI, Nanjing (CN); Fahua ZHU, Nanjing (CN); Jiaming GU, Zhuhai (CN); Qian ZHANG, Nanjing (CN); Jingxin XU, Nanjing (CN)

(73) Assignees: China Energy Science and Technology Research Institute Co., Ltd., Nanjing City (CN); Southeast University, Nanjing (CN)

(21) Appl. No.: 18/649,023

(22) Filed: Apr. 29, 2024

(30) Foreign Application Priority Data
Feb. 22, 2024 (CN) 202410201138.1

(51) Int. Cl. C04B 7/24; C04B 14/06; C04B 18/14; C04B 20/00; C04B 20/04; C04B 28/02; D01F 9/12; D03D 15/275; H01G 11/36; H01G 11/38; H01G 11/86

(52) U.S. Cl. CPC C04B 7/243; C04B 14/068; C04B 18/141; C04B 18/146; C04B 20/0048; C04B 20/04; C04B 28/021; D01F 9/12; D03D 15/275; H01G 11/36; H01G 11/38; H01G 11/86; D10B 2101/122

(57) ABSTRACT

The present disclosure relates to the technical field of preparation of supercapacitor and geopolymeric concrete and discloses a carbon nanotube fly ash composite material and a preparation method and use thereof. The carbon nanotube fly ash composite material comprises an acidified carbon nanotube fiber fabric and a fly ash compound attached to the acidified carbon nanotube fiber fabric, wherein the fly ash compound comprises a cementitious material, a fine aggregate, an alkali activator, and carbon fibers, wherein the cementitious material is a mixture of fly ash, slag, and silica fume. The carbon nanotube fly ash composite material has desirable strength, ductility, and specific surface area, and an asymmetric supercapacitor prepared with the carbon nanotube fly ash composite material has stable properties, high charge-discharge efficiency, and high energy density and power density, and can be utilized in the aspects of large-capacity energy storage such as dwelling, transportation and industrial application.

### CROSS-REFERENCE TO RELATED APPLICATIONS

The application claims priority to Chinese Application No. 202410201138.1, filed on Feb. 22, 2024, entitled “Carbon nanotube fly ash composite material and Preparation method and Use thereof”, which is herein specifically and entirely incorporated by reference.

### FIELD

The present disclosure relates to the technical field of preparation of supercapacitor and geopolymeric concrete, in particular to a carbon nanotube fly ash composite material and a preparation method and use thereof.

### BACKGROUND

Traditional fossil fuel has gradually transformed into renewable energy along with the high-speed development of electric energy utilization technologies and the further increased energy demand of human society; moreover, in order to achieve the goals of sustainable development, countries in the world have intensified the research and development efforts on the key technologies in the fields of renewable energy such as wind energy, solar energy, and tidal energy, it requires that the energy storage equipment can achieve the expansibility and controllability of energy supply.

The existing supercapacitors use porous materials (e.g., activated carbon) with a high specific surface area as electrodes, the positive electrode and the negative electrode are immersed in an electrolyte, and the electrodes are separated by an ion-permeable diaphragm to prevent electrical contact. In the charged state, the anions and cations in the electrolyte move towards the positive electrode and the negative electrode respectively, thereby forming two electric double layers (EDLs) at an interface of the electrode-electrolyte, and the separation of said ions also causes a potential difference presented in the whole cell component. Therefore, the existing supercapacitors need an ion-permeable diaphragm and have defects such as complex use conditions, unstable properties, and low charge-discharge efficiency.

Carbon Nanotubes (CNTs) exhibit desirable conductivity due to their network structure, which reduces inter-particle contact and contact resistance, thus the CNTs have emerged as the main materials for preparing the supercapacitors.

### SUMMARY

The present disclosure aims to overcome the defects in the prior art and provide a carbon nanotube fly ash composite material, and an asymmetric supercapacitor prepared with the carbon nanotube fly ash composite material that has excellent specific capacitance, rate capability, stability, and cycle performance.

To achieve the above object, the first aspect of the present disclosure provides a carbon nanotube fly ash composite material, comprising an acidified carbon nanotube fiber fabric and a fly ash compound attached to the acidified carbon nanotube fiber fabric, wherein the fly ash compound comprises a cementitious material, a fine aggregate, an alkali activator, and carbon fibers, wherein the cementitious material is a mixture of fly ash, slag, and silica fume.

Preferably, the acidified carbon nanotube fiber fabric is obtained by subjecting a carbon nanotube fiber fabric to heat treatment and acidification treatment in sequence.

Preferably, the raw materials for preparing the carbon nanotube fiber fabric comprise a liquid-state carbon-containing organic substance, an iron-containing organic salt, and a sulfur-containing organic substance.

Preferably, the weight ratio of dosage of the liquid state carbon-containing organic substance to the iron-containing organic salt is (410-450):1, wherein the liquid state carbon-containing organic substance is calculated in terms of carbon element, and the iron-containing organic salt is calculated in terms of the iron element.

Preferably, the weight ratio of dosage of the liquid state carbon-containing organic substance to the sulfur-containing organic substance is (210-250):1, wherein the liquid state carbon-containing organic substance is calculated in terms of carbon element, and the sulfur-containing organic substance is calculated in terms of the sulfur element.

Preferably, the cementitious material contains fly ash in an amount of 70-80 wt %, slag in an amount of 15-20 wt %, and silica fume in an amount of 5-10 wt %, based on the total weight of said cementitious material.

Preferably, the fly ash is Grade I calcium ash, wherein the content of CaO is not less than 90 wt %.

Preferably, the slag contains Al₂O₃ and SiO₂ in an amount of 50 wt % or more, the slag has a specific surface area within the range of 600-800 m²/kg, and the screen residue of 45 μm square-hole sieve being less than 1%.

Preferably, the silica fume has a particle size within the range of 0.1-0.3 μm, and a specific surface area within the range of 15,000-30,000 m²/kg.

Preferably, the fine aggregate has a particle size within the range of 1,500-2,300 μm.

Preferably, the fine aggregate is river sand.

Preferably, the weight ratio of the fine aggregate to the cementitious material in the fly ash compound is within the range of 1:(2-4).

Preferably, the alkali activator is contained in the fly ash compound in an amount of 17.5-52.5 parts by weight, relative to 100 parts by weight of the total weight of the fine aggregate and the cementitious material.

Preferably, the alkali activator is a mixture of a strong base and sodium silicate.

Preferably, the weight ratio of the strong base to the sodium silicate in the alkali activator is within the range of (0.2-0.6):1.

Preferably, the carbon fiber is contained in the fly ash compound in an amount of 0.5-1 part by weight, relative to 100 parts by weight of the total weight of the fine aggregate and the cementitious material.

Preferably, the acidified carbon nanotube fiber fabric is present in an amount of 1-18 parts by weight, more preferably 3.3-16.5 parts by weight, relative to 100 parts by weight of the total weight of the fine aggregate and the cementitious material.

In the second aspect, the present disclosure provides a method for preparing the aforementioned carbon nanotube fly ash composite material, the method comprises the following steps:
S1: blending a fine aggregate, a cementitious material, carbon fibers, and an alkali activator to obtain a fly ash compound slurry;
S2: subjecting a carbon nanotube fiber fabric to heat treatment and acidification treatment in sequence to obtain an acidified carbon nanotube fiber fabric;
S3: soaking the acidified carbon nanotube fiber fabric obtained in step S2 in the fly ash compound slurry obtained in step S1, then transferring the obtained material into an electrode mold for curing, followed by demolding and polishing.

Preferably, the method further comprises preparing the carbon nanotube fiber fabric according to the following processes:
A1: mixing a liquid state carbon-containing organic substance, an iron-containing organic salt, and a sulfur-containing organic substance, roasting the mixture in an inert atmosphere to obtain a carbon nanotube aerogel, and then subjecting the carbon nanotube aerogel to a water bath to form carbon nanotube fibers;
A2: twisting the carbon nanotube fibers obtained in the process A1 into yarns, and then weaving the yarns into a carbon nanotube fiber fabric.

Preferably, the conditions of roasting in process A1 comprise the temperature within the range of 350-450° C. and the time within the range of 45-75 min.

Preferably, the conditions of heat treatment in step S2 comprise the temperature within the range of 380-420° C. and the time within the range of 45-75 min.

Preferably, the acidification treatment in step S2 is to mix the heat-treated carbon nanotube fiber fabric with an acidic solution, and the mixing conditions comprise the temperature within the range of 40-50° C. and the time within the range of 5.5-6.5 h.

In the third aspect, the present disclosure provides an asymmetric supercapacitor comprising a first fabric electrode, a second fabric electrode, and a diaphragm disposed between the first fabric electrode and the second fabric electrode, the first fabric electrode is the aforementioned carbon nanotube fly ash composite material.

Preferably, the second fabric electrode comprises a nickel cobaltate nanowire-loaded and nitrogen-doped carbon nanotube fiber fabric, and a fly ash compound attached to the nickel cobaltate nanowire-loaded and nitrogen-doped carbon nanotube fiber fabric.

Preferably, the second fabric electrode is prepared according to the following processes:
B1: blending dopamine hydrochloride, water, and nanotube fiber fabric, adjusting the pH of the solution to within a range of 8-11 to obtain a polydopamine-coated nanotube fiber fabric, and then roasting in a nitrogen atmosphere to obtain a fabric A;
B2: mixing fabric A, a nickel precursor solution, a cobalt precursor solution, and urea, then carrying out a hydrothermal reaction to obtain a fabric B, taking out fabric B and carrying out thermal treatment, and then blending with a fly ash compound slurry, subsequently transferring the obtained material into an electrode mold for curing, followed by demolding and polishing.

Compared with the prior art, the present disclosure has the following advantages:
(1) The carbon nanotube fly ash composite material in the present disclosure has desirable ductility and strength, the reason may be that the cementitious material in the raw materials is an inorganic cementitious material, which can be favorably bonded with the carbon fibers and the carbon nanotube fiber fabric, such that the ductility and strength are balanced;
(2) The carbon nanotube fly ash composite material in the present disclosure has a large specific surface area, and can favorably contact with the electrolyte solution, thus the carbon nanotube fly ash composite material exhibits excellent conductivity;
(3) The asymmetric supercapacitor of the present disclosure has stable properties, its capacity and internal resistance are only reduced by 5-10% after 1,750,000 cycles of quick charging and discharging, the charge-discharge efficiency is high, and the maximum energy density can reach 284.13 μWh/cm²;
(4) The asymmetric supercapacitor of the present disclosure can be used in large-capacity energy storage in dwelling, transportation, and industrial applications, and has wider application ranges.

### BRIEF DESCRIPTION OF THE DRAWINGS

FIG. 1 illustrates an electron micrograph of the second fabric electrode prepared in Example 1 of the present disclosure;

FIG. 2 illustrates an electron micrograph of the carbon nanotube fly ash composite material prepared in Example 1 of the present disclosure.

### DETAILED DESCRIPTION

The specific embodiments of the present disclosure will be described in detail below with reference to the appended figures. It should be understood that the specific embodiments described herein merely serve to illustrate and explain the present disclosure, instead of imposing restrictions thereon.

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined to produce one or more new numerical ranges, which should be deemed to have been specifically disclosed herein.

The first aspect of the present disclosure provides a carbon nanotube fly ash composite material, comprising an acidified carbon nanotube fiber fabric and a fly ash compound attached to the acidified carbon nanotube fiber fabric, wherein the fly ash compound comprises a cementitious material, a fine aggregate, an alkali activator, and carbon fibers, wherein the cementitious material is a mixture of fly ash, slag, and silica fume.

In a preferred embodiment, the acidified carbon nanotube fiber fabric is obtained by subjecting a carbon nanotube fiber fabric to heat treatment and acidification treatment in sequence.

In a preferred embodiment, the raw materials for preparing the carbon nanotube fiber fabric comprise a liquid-state carbon-containing organic substance, an iron-containing organic salt, and a sulfur-containing organic substance.

In a preferred embodiment, the weight ratio of dosage of the liquid state carbon-containing organic substance to the iron-containing organic salt is (410-450):1, wherein the liquid state carbon-containing organic substance is calculated in terms of carbon element, and the iron-containing organic salt is calculated in terms of iron element; specifically, the weight ratio may be 410:1, 420:1, 430:1, 440:1, or 450:1.

In a preferred embodiment, the weight ratio of dosage of the liquid state carbon-containing organic substance to the sulfur-containing organic substance is (210-250):1, wherein the liquid state carbon-containing organic substance is calculated in terms of carbon element, and the sulfur-containing organic substance is calculated in terms of sulfur element; specifically, the weight ratio may be 210:1, 220:1, 225:1, 230:1, 240:1, or 250:1.

In the present disclosure, the liquid state carbon-containing organic substance refers to a carbon-containing organic substance that is liquid at room temperature. There is no particular requirement for the specific kinds of liquid-state carbon-containing organic substance, iron-containing organic salt, and sulfur-containing organic substance, each of them may be conventionally used in the art. In a more preferred embodiment, the liquid state carbon-containing organic substance is ethanol and/or acetone; the iron-containing organic salt is ferrocene; and the sulfur-containing organic substance is thiophene.

In a preferred embodiment, for the sake of improving ductility and strength of the carbon nanotube fly ash composite material, the cementitious material contains fly ash in an amount of 70-80 wt %, slag in an amount of 15-20 wt %, and silica fume in an amount of 5-10 wt %, based on the total weight of said cementitious material; specifically, the content of fly ash may be 70 wt %, 75 wt %, or 80 wt %; the content of slag may be 15 wt %, or 20 wt %; the content of silica fume may be 5 wt %, or 10 wt %.

In a preferred embodiment, the fly ash is Grade I calcium ash, wherein the content of CaO is not less than 90 wt %.

In a preferred embodiment, the slag contains Al₂O₃ and SiO₂ in an amount of 50 wt % or more, the slag has a specific surface area within the range of 600-800 m²/kg, and the screen residue of 45 μm square-hole sieve is less than 1%.

In a preferred embodiment, the silica fume has a particle size within the range of 0.1-0.3 μm, and a specific surface area within the range of 15,000-30,000 μm²/kg.

In a preferred embodiment, the fine aggregate has a particle size within the range of 1,500-2,300 μm.

In a preferred embodiment, the fine aggregate is river sand.

In a preferred embodiment, in the fly ash compound, the weight ratio of the fine aggregate to the cementitious material in the fly ash compound is within the range of 1:(2-4); specifically, the weight ratio of the fine aggregate to the cementitious material may be 1:2, 1:2.5, 1:3, 1:3.5, or 1:4.

In a preferred embodiment, the alkali activator is contained in the fly ash compound in an amount of 17.5-52.5 parts by weight, relative to 100 parts by weight of the total weight of the fine aggregate and the cementitious material, such that the cementitious material can favorably generate a gel; specifically, the alkali activator may be contained in an amount of 17.5 parts by weight, 20 parts by weight, 25 parts by weight, 30 parts by weight, 35 parts by weight, 40 parts by weight, 45 parts by weight, 50 parts by weight, or 52.5 parts by weight.

In a preferred embodiment, the alkali activator is a mixture of a strong base and sodium silicate.

In a more preferred embodiment, the weight ratio of the strong base to the sodium silicate in the alkali activator is within the range of (0.2-0.6):1; specifically, the weight ratio of the strong base to the sodium silicate in the alkali activator maybe 0.2:1, 0.3:1, 0.4:1, 0.5:1, or 0.6:1.

The present disclosure does not impose particular requirements on the strong base, which may be any strong base conventionally used in the art, for example, the strong base may be sodium hydroxide or potassium hydroxide.

In a preferred embodiment, the carbon fiber is contained in the fly ash compound in an amount of 0.5-1 part by weight, relative to 100 parts by weight of the total weight of the fine aggregate and the cementitious material, so that the fine aggregate and the cementitious material can be desirably bonded to the carbon fibers, increasing the ductility and strength of the carbon nanotube fly ash composite material; specifically, the weight ratio of the total weight of the fine aggregate and the cementitious material to the carbon fibers maybe 100:0.5, 100:0.8, or 100:1.

In a preferred embodiment, in order to further improve the stability of the carbon nanotube fly ash composite material, the carbon fibers have a monofilament diameter within the range of 7-14 μm, the carbon content more than or equal to 97%, the density within the range of 1.75-1.98 g/cm³, the tensile strength more than or equal to 3,500 GPa, and the resistivity less than or equal to 1.2 Ω/cm.

In a preferred embodiment, for the sake of increasing the energy density and strength of the carbon nanotube fly ash composite material, the acidified carbon nanotube fiber fabric is present in an amount of 1-18 parts by weight, preferably 3.3-16.5 parts by weight, relative to 100 parts by weight of the total weight of the fine aggregate and the cementitious material; specifically, the weight ratio of the total weight of the fine aggregate and the cementitious material to the carbon nanotube fiber fabric maybe 100:3.3, 100:6.6, 100:9.9, 100:15, or 100:16.5.

In the second aspect, the present disclosure provides a method for preparing the aforementioned carbon nanotube fly ash composite material, the method comprises the following steps:
S1: blending a fine aggregate, a cementitious material, carbon fibers, and an alkali activator to obtain a fly ash compound slurry;
S2: subjecting a carbon nanotube fiber fabric to heat treatment and acidification treatment in sequence to obtain an acidified carbon nanotube fiber fabric;
S3: soaking the acidified carbon nanotube fiber fabric obtained in step S2 in the fly ash compound slurry obtained in step S1, then transferring the obtained material into an electrode mold for curing, followed by demolding and polishing.

In the present disclosure, the carbon nanotube fly ash composite material prepared with the method has a large specific surface area and desirable conductivity.

In a preferred embodiment, in order to improve uniformity of the fly ash compound slurry, in step S1, a fine aggregate, a cementitious material, carbon fibers and an alkali activator are blended in the presence of water by stirring at a stirring rate of 300-500 r/min for the stirring time of 3-5 min; specifically, the stirring rate may be 300 r/min, 350 r/min, 400 r/min, 450 r/min or 500 r/min; the stirring time may be 3 min, 4 min, or 5 min.

In the present disclosure, there is no particular requirement for the used amount of water, as long as the fine aggregate, the cementitious material, the carbon fibers, and the alkali activator can be uniformly blended.

In a preferred embodiment, the method for preparing the aforementioned carbon nanotube fly ash composite material further comprises preparing the carbon nanotube fiber fabric according to the following processes:
A1: mixing a liquid state carbon-containing organic substance, an iron-containing organic salt, and a sulfur-containing organic substance, roasting the mixture in an inert atmosphere to obtain a carbon nanotube aerogel, and then subjecting the carbon nanotube aerogel to a water bath to form carbon nanotube fibers;
A2: twisting the carbon nanotube fibers obtained in the process A1 into yarns, and then weaving the yarns into a carbon nanotube fiber fabric.

In a preferred embodiment, the inert gas atmosphere in process A1 may be a nitrogen gas atmosphere, argon gas atmosphere, or helium gas atmosphere.

In a preferred embodiment, the conditions of roasting in process A1 comprise: the temperature within the range of 350-450° C., and the time within the range of 45-75 min; specifically, the temperature may be 350° C., 380° C., 400° C., 420° C., or 450° C.; the time may be 45 min, 60 min, or 75 min.

In the present disclosure, in process A2, the twisted carbon nanotube fibers are woven into Carbon Nanotube Fiber Fabric (CNTFF) by an automatic knitting machine, and there is no special requirement for the twist degree of twisting, it may be the conventional twist degree in the art, for example, 2,000 Tm⁻¹.

In a preferred embodiment, the conditions of heat treatment in step S2 comprise: the temperature within the range of 380-420° C., and the time within the range of 45-75 min; specifically, the temperature can be 380° C., 400° C. or 420° C.; the time may be 45 min, 60 min, or 75 min.

In a preferred embodiment, the acidification treatment in step S2 is to mix the heat-treated carbon nanotube fiber fabric with an acidic solution, and the mixing conditions comprise the temperature within the range of 40-50° C. and the time within the range of 5.5-6.5 h; specifically, the temperature may be 40° C., 45° C., or 50° C.; the time maybe 5.5 h, 6 h, or 6.5 h.

In the present disclosure, there is no particular requirement on the acidic solution in step S2 and the used amount of the acidic solution, both may be conventional used in the art.

In a preferred embodiment, the acid of the acidic solution is one or more selected from the group consisting of sulfuric acid, nitric acid, and hydrochloric acid; the used amount of the acidic solution is not specifically required, as long as the heat-treated carbon nanotube fiber fabric can be completely immersed in the acidic solution.

In a preferred embodiment, the curing temperature in step S3 is within the range of 10-30° C., and the curing time is within the range of 12-36 h; specifically, the curing temperature may be 10° C., 20° C., or 30° C.; the curing time may be 12 h, 24 h, or 36 h.

The third aspect of the present disclosure provides an asymmetric supercapacitor comprising a first fabric electrode, a second fabric electrode, and a diaphragm disposed between the first fabric electrode and the second fabric electrode, wherein the first fabric electrode is the aforementioned carbon nanotube fly ash composite material.

In a specific embodiment, the diaphragm is a cotton fabric.

In a preferred embodiment, the second fabric electrode comprises a nickel cobaltate nanowire-loaded and nitrogen-doped carbon nanotube fiber fabric, and a fly ash compound attached to the nickel cobaltate nanowire-loaded and nitrogen-doped carbon nanotube fiber fabric.

In a preferred embodiment, the second fabric electrode is prepared according to the following processes:
B1: blending dopamine hydrochloride, water, and nanotube fiber fabric, adjusting the pH of the solution to within a range of 8-11 to obtain a polydopamine-coated nanotube fiber fabric, and then roasting in a nitrogen atmosphere to obtain a fabric A;
B2: mixing fabric A, a nickel precursor solution, a cobalt precursor solution, and urea, then carrying out a hydrothermal reaction to obtain a fabric B, taking out fabric B and carrying out thermal treatment, and then blending with a fly ash compound slurry, subsequently transferring the obtained material into an electrode mold for curing, followed by demolding and polishing.

In the method of the present disclosure, in process B1, the polydopamine-coated nanotube fiber fabric obtained by treatment with dopamine hydrochloride has increased hydrophilicity and specific surface area, and nitrogen elements are doped by roasting the polydopamine-coated nanotube fiber fabric in a nitrogen gas atmosphere, NiCo₂O₄ is grown on the surface of the fabric A through a hydrothermal method and heat treatment to obtain a fabric B, the fabric B and fly ash compound slurry are mixed to obtain a second fabric electrode with high area specific capacitance, desirable rate capability, and cycle performance.

In a preferred embodiment, the conditions of roasting in process B1 comprise the temperature within the range of 750-850° C., and the time within the range of 1.5-2.5 h; specifically, the temperature may be 750° C., 800° C., or 850° C.; the time maybe 1.5 h, 2 h, or 2.5 h.

In the present disclosure, there is no particular requirement for the used amount of dopamine hydrochloride in process B1, as long as the finally obtained polypolydopamine can coat the nanotube fiber fabric.

In a preferred embodiment, the molar equivalent ratio of the used amounts of the nickel precursor, the cobalt precursor, and urea in the process B2 is 1:(1.5-2.5):(4-6); specifically, the molar equivalent ratio of the used amounts of the nickel precursor, the cobalt precursor, and urea maybe 1:1.5:4, 1:1.5:5, 1:1.5:6, 1:2:4, 1:2:5, 1:2:6, 1:2.5:4, 1:2.5:5, or 1:2.5:6.

In the present disclosure, there is no particular requirement for the nickel precursor and the cobalt precursor in the process B2, both may be conventionally used compounds in the art, for example, the nickel precursor may be nickel nitrate hexahydrate or nickel nitrate; the cobalt precursor may be cobalt nitrate hexahydrate or cobalt nitrate.

In a preferred embodiment, the conditions of hydrothermal reaction in the process B2 comprise the temperature within the range of 100-140° C., and the time within the range of 5.5-6.5 h; specifically, the temperature maybe 100° C., 110° C., 120° C., 130° C., or 140° C.; the time may be 5.5 h, 6 h, or 6.5 h.

In a preferred embodiment, the conditions of heat treatment in process B2 comprise: the temperature within the range of 280-320° C., and the time within the range of 1.5-2.5 h; specifically, the temperature may be 280° C., 290° C., 300° C., 310° C., or 320° C.; the time may be 1.5 h, 2 h, or 2.5 h.

In the present disclosure, process B2 further comprises washing and drying operations between the hydrothermal reaction and the heat treatment, and there is no particular requirement for the drying and washing operations, both may be implemented with any commonly used mode in the art.

In a preferable embodiment, in process B2, the curing temperature is within the range of 10-30° C., and the curing time is within the range of 12-36 h; specifically, the curing temperature may be 10° C., 20° C., or 30° C.; the curing time may be 12 h, 24 h, or 36 h.

The asymmetric supercapacitor provided by the present disclosure has stable properties, high charge-discharge efficiency, and high energy density and power density.

A carbon nanotube fly ash composite material, a preparation method, and the use thereof in the present disclosure are further illustrated with reference to the following examples. The examples are implemented on the premise of the technical scheme of the present disclosure, and the examples provide detailed embodiments and specific operation processes, but the protection scopes of the present disclosure are not limited to the following examples.

Unless otherwise specified, each of the experimental methods in the following examples pertained to the conventional methods in the art. The experimental materials used in the following examples were as follows: fine aggregate: river sand with a particle size within the range of 1,500-2,300 μm, commercially available; fly ash: Grade I calcium ash with the CaO content of 95 wt %; slag: the specific surface area was within the range of 600-800 m²/kg, and the screen residue of 45 μm square-hole sieve was less than 1%; silica fume: the grain diameter was within the range of 0.1-0.3 μm, and the specific surface area was within the range of 15,000-30,000 m²/kg; carbon fibers: commercially available, the diameter of the single yarn was 7 μm, the carbon content was more than or equal to 97 wt %, the density was 1.75 g/cm³, the tensile strength was more than or equal to 3,500 GPa, and the electrical resistivity was less than or equal to 1.2 Ω/cm; ethanol: analytically pure AR99.7%, purchased from the Sinopharm Chemical Reagent Co., Ltd.; ferrocene: its melting point was within the range of 172-174° C., the content of benzene insoluble substance was less than or equal to 0.1 wt %, the content of free iron was less than or equal to 0.1 wt %, moisture content was less than or equal to 0.1 wt %, analytically pure, 98%, purchased from the Sinopharm Chemical Reagent Co., Ltd.; thiophene: content was larger than or equal to 99 wt %, manufactured by Sigma-Aldrich Corporation; the Carbon Nanotube Fiber Fabric (CNTFF) was prepared by the following processes: A1: ethanol, ferrocene and thiophene were mixed, the mixture was then roasted in a tubular furnace under nitrogen gas atmosphere to obtain carbon nanotube aerogel, wherein the weight ratio of the ethanol to the ferrocene was 430:1, the weight ratio of the used amount of the ethanol to the used amount of the thiophene is 226:1, respectively; ethanol, ferrocene, and thiophene were calculated in terms of carbon element, iron element, and sulfur element respectively; the roasting was implemented at the temperature of 350° C. for the time of 45 min, and then subjected to a water bath to form carbon nanotube fibers; A2: 10 carbon nanotube fibers obtained in the process A1 were twisted into a yarn with a twist degree of 2,000 Tm⁻¹ by means of a twisting machine, 6 strands of the prepared carbon nanotube yarns were knitted into a Carbon Nanotube Fiber Fabric (CNTFF) by means of an automatic knitting machine, and other experimental materials, unless otherwise specified, were commercially available.

### Example 1

### Preparation of the Carbon Nanotube Fly Ash Composite Material M1:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K1 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:0.5, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:3.3, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K1 obtained in step S1, the obtained material was then transferred into an electrode mold for curing at the temperature of 20° C. for 24 hours, and then subjected to demolding and polishing to obtain a carbon nanotube fly ash composite material M1 (the micro-morphology was as shown in FIG. 2);

### Preparation of the Second Fabric Electrode D1:

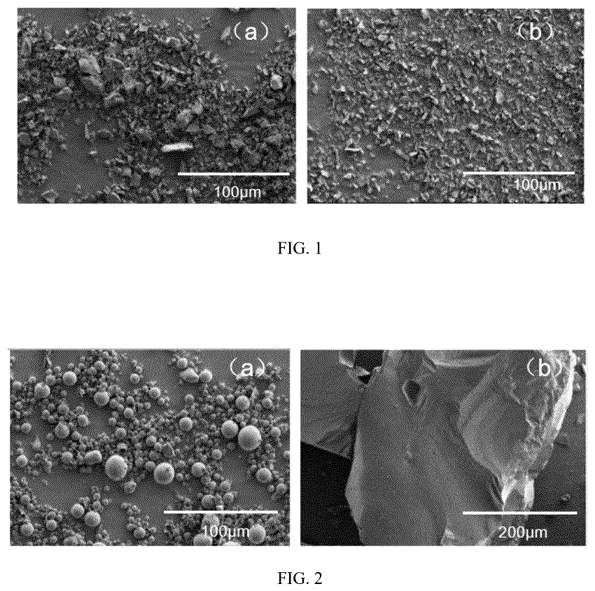

B1: 2 mg·mL⁻¹ dopamine hydrochloride was dissolved in 50 ml of water, the nanotube fiber fabric was then added and mixed, the pH of the solution was adjusted to 8.5, and stirred at the temperature of 20° C. for 24 hours to obtain a polydopamine-coated nanotube fiber fabric, which was subjected to washing and drying, and then roasting in a nitrogen atmosphere to obtain a fabric A, wherein the roasting temperature was 800° C. and the roasting time was 2 h;
B2: nickel nitrate hexahydrate (2 mmol), cobalt nitrate hexahydrate (4 mmol), and urea (10 mmol) were dissolved in 40 mL of water, and the fabric A was added, the mixture was then placed in a stainless steel reaction kettle with a polytetrafluoroethylene lining at 120° C. for a hydrothermal reaction for 6 h to obtain a fabric B, which was taken out and washed with ethanol and deionized water, and dried in a vacuum oven at 60° C. for 12 h, and then placed in a tube furnace for heat treatment for 2 h at 300° C. (the temperature rise rate was 2° C./min) for 2 h, the fabric B was subsequently soaked in a fly ash compound slurry K1, transferred into an electrode mold for curing at the temperature of 20° C. for 24 h, and then subjected to demolding and polishing to obtain a second fabric electrode D1 (the micro-morphology was as shown in FIG. 1);

A cotton fabric and the second fabric electrode D1 were laminated on the surface of the carbon nanotube fly ash composite material M1 in sequence, and assembled to form an asymmetric supercapacitor N1.

### Example 2

### Preparation of the Carbon Nanotube Fly Ash Composite Material M2:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K1 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:0.5, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:9.9, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K1 obtained in step S1, the obtained material was then transferred into an electrode mold for curing at the temperature of 20° C. for 24 hours, and then subjected to demolding and polishing to obtain a carbon nanotube fly ash composite material M2;

The second fabric electrode D1 was prepared according to the same method as that in Example 1;

A cotton fabric and the second fabric electrode D1 were laminated on the surface of the carbon nanotube fly ash composite material M2 in sequence, and assembled to form an asymmetric supercapacitor N2.

### Example 3

### Preparation of the Carbon Nanotube Fly Ash Composite Material M3:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K1 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:0.5, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:16.5, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K1 obtained in step S1, the obtained material was then transferred into an electrode mold for curing at the temperature of 20° C. for 24 hours, and then subjected to demolding and polishing to obtain a carbon nanotube fly ash composite material M3;

The second fabric electrode D1 was prepared according to the same method as that in Example 1;

A cotton fabric and the second fabric electrode D1 were laminated on the surface of the carbon nanotube fly ash composite material M3 in sequence, and assembled to form an asymmetric supercapacitor N3.

### Example 4

### Preparation of the Carbon Nanotube Fly Ash Composite Material M4:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K2 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:3.3, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K2 obtained in step S1, the obtained material was then transferred into an electrode mold for curing at the temperature of 20° C. for 24 hours, and then subjected to demolding and polishing to obtain a carbon nanotube fly ash composite material M4;

### Preparation of the Second Fabric Electrode D2:

B1: 2 mg mL⁻¹ dopamine hydrochloride was dissolved in 50 ml of water, the nanotube fiber fabric was then added and mixed, the pH of the solution was adjusted to 8.5, and stirred at the temperature of 20° C. for 24 hours to obtain a polydopamine-coated nanotube fiber fabric, which was subjected to washing and drying, and then roasting in a nitrogen atmosphere to obtain a fabric A, wherein the roasting temperature was 800° C. and the roasting time was 2 h;
B2: nickel nitrate hexahydrate (2 mmol), cobalt nitrate hexahydrate (4 mmol), and urea (10 mmol) were dissolved in 40 mL of water, and the fabric A was added, the mixture was then placed in a stainless steel reaction kettle with a polytetrafluoroethylene lining at 120° C. for a hydrothermal reaction for 6 h to obtain a fabric B, which was taken out and washed with ethanol and deionized water, and dried in a vacuum oven at 60° C. for 12 h, and then placed in a tube furnace for heat treatment for 2 h at 300° C. (the temperature rise rate was 2° C./min) for 2 h, the fabric B was subsequently soaked in a fly ash compound slurry K2, transferred into an electrode mold for curing at the temperature of 20° C. for 24 h, and then subjected to demolding and polishing to obtain a second fabric electrode D2;

A cotton fabric and the second fabric electrode D2 were laminated on the surface of the carbon nanotube fly ash composite material M4 in sequence, and assembled to form an asymmetric supercapacitor N4.

### Example 5

### Preparation of the Carbon Nanotube Fly Ash Composite Material M5:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K2 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
   S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:9.9, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K2 obtained in step S1, the obtained material was then transferred into an electrode mold for curing at the temperature of 20° C. for 24 hours, and then subjected to demolding and polishing to obtain a carbon nanotube fly ash composite material M5;

The second fabric electrode D2 was prepared according to the same method as that in Example 4;

A cotton fabric and the second fabric electrode D2 were laminated on the surface of the carbon nanotube fly ash composite material M5 in sequence, and assembled to form an asymmetric supercapacitor N5.

### Example 6

### Preparation of the Carbon Nanotube Fly Ash Composite Material M6:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K2 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:16.5, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K2 obtained in step S1, the obtained material was then transferred into an electrode mold for curing at the temperature of 20° C. for 24 hours, and then subjected to demolding and polishing to obtain a carbon nanotube fly ash composite material M6;

The second fabric electrode D2 was prepared according to the same method as that in Example 4;

A cotton fabric and the second fabric electrode D2 were laminated on the surface of the carbon nanotube fly ash composite material M6 in sequence, and assembled to form an asymmetric supercapacitor N6.

### Example 7

### Preparation of the Carbon Nanotube Fly Ash Composite Material M7:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K3 was obtained; wherein the weight ratio of dosage of the river sand to the cementitious material was 1:4; the cementitious material contained fly ash in an amount of 80 wt % of fly ash, a slab in an amount of 15 wt %, and silica fume in an amount of 5 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:16.5, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K3 obtained in step S1, the obtained material was then transferred into an electrode mold for curing at the temperature of 20° C. for 24 hours, and then subjected to demolding and polishing to obtain a carbon nanotube fly ash composite material M7;

### Preparation of the Second Fabric Electrode D3:

B1: 2 mg mL⁻¹ dopamine hydrochloride was dissolved in 50 ml of water, the nanotube fiber fabric was then added and mixed, the pH of the solution was adjusted to 8.5, and stirred at the temperature of 20° C. for 24 hours to obtain a polydopamine-coated nanotube fiber fabric, which was subjected to washing and drying, and then roasting in a nitrogen atmosphere to obtain a fabric A, wherein the roasting temperature was 800° C. and the roasting time was 2 h;
B2: nickel nitrate hexahydrate (2 mmol), cobalt nitrate hexahydrate (4 mmol), and urea (10 mmol) were dissolved in 40 mL of water, and the fabric A was added, the mixture was then placed in a stainless steel reaction kettle with a polytetrafluoroethylene lining at 120° C. for a hydrothermal reaction for 6 h to obtain a fabric B, which was taken out and washed with ethanol and deionized water, and dried in a vacuum oven at 60° C. for 12 h, and then placed in a tube furnace for heat treatment for 2 h at 300° C. (the temperature rise rate was 2° C./min) for 2 h, the fabric B was subsequently soaked in a fly ash compound slurry K3, transferred into an electrode mold for curing at the temperature of 20° C. for 24 h, and then subjected to demolding and polishing to obtain a second fabric electrode D3;

A cotton fabric and the second fabric electrode D3 were laminated on the surface of the carbon nanotube fly ash composite material M7 in sequence, and assembled to form an asymmetric supercapacitor N7.

### Example 8

### Preparation of the Carbon Nanotube Fly Ash Composite Material M8:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K2 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:20, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K2 obtained in step S1, the obtained material was then transferred into an electrode mold for curing at the temperature of 20° C. for 24 hours, and then subjected to demolding and polishing to obtain a carbon nanotube fly ash composite material M8;

The second fabric electrode D2 was prepared according to the same method as that in Example 4;

A cotton fabric and the second fabric electrode D2 were laminated on the surface of the carbon nanotube fly ash composite material M8 in sequence, and assembled to form an asymmetric supercapacitor N8.

### Example 9

### Preparation of the Carbon Nanotube Fly Ash Composite Material M4:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K4 was obtained; wherein the weight ratio of dosage of the river sand to the cementitious material was 1:4; the cementitious material contained fly ash in an amount of 90 wt % of fly ash, a slab in an amount of 5 wt %, and silica fume in an amount of 5 wt %; the weight ratio of the total weight of the river sand and the cementitious material to the carbon fibers was 100:1, the weight ratio of the total weight of the river sand and the cementitious material to the alkali activator was 100:35, the weight ratio of NaOH to sodium silicate in the alkali activator was 0.4:1;
S2: the carbon nanotube fiber fabric was put into a tube furnace and subjected to heat treatment under an air atmosphere, wherein the weight ratio of the total weight of the river sand and the cementitious material to the carbon nanotube fiber fabric was 100:16.5, the heat treatment was performed at a temperature of 400° C. for 1 h, the carbon nanotube fiber fabric was then subjected to an acidification treatment with 80 mL of an acid solution (composed of 60 mL of concentrated sulfuric acid and 20 mL of concentrated nitric acid), the acidification treatment was carried out at a temperature of 45° C. for 6 h, the carbon nanotube fiber fabric following the acidification treatment was washed, and then dried at 60° C. for 8 h under vacuum to obtain the acidified carbon nanotube fiber fabric;
S3: the acidified nanotube fiber fabric obtained in step S2 was soaked in the fly ash compound slurry K4 obtained in step S1, the obtained material was then transferred into an electrode mold for curing at the temperature of 20° C. for 24 hours, and then subjected to demolding and polishing to obtain a carbon nanotube fly ash composite material M9;

### Preparation of the Second Fabric Electrode D4:

B1: 2 mg·mL⁻¹ dopamine hydrochloride was dissolved in 50 ml of water, the nanotube fiber fabric was then added and mixed, the pH of the solution was adjusted to 8.5, and stirred at the temperature of 20° C. for 24 hours to obtain a polydopamine-coated nanotube fiber fabric, which was subjected to washing and drying, and then roasting in a nitrogen atmosphere to obtain a fabric A, wherein the roasting temperature was 800° C. and the roasting time was 2 h;
B2: nickel nitrate hexahydrate (2 mmol), cobalt nitrate hexahydrate (4 mmol), and urea (10 mmol) were dissolved in 40 mL of water, and the fabric A was added, the mixture was then placed in a stainless steel reaction kettle with a polytetrafluoroethylene lining at 120° C. for a hydrothermal reaction for 6 h to obtain a fabric B, which was taken out and washed with ethanol and deionized water, and dried in a vacuum oven at 60° C. for 12 h, and then placed in a tube furnace for heat treatment for 2 h at 300° C. (the temperature rise rate was 2° C./min) for 2 h, the fabric B was subsequently soaked in a fly ash compound slurry K4, transferred into an electrode mold for curing at the temperature of 20° C. for 24 h, and then subjected to demolding and polishing to obtain a second fabric electrode D4;

A cotton fabric and the second fabric electrode D4 were laminated on the surface of the carbon nanotube fly ash composite material M9 in sequence, and assembled to form an asymmetric supercapacitor N9.

### Comparative Example 1

The carbon nanotube fly ash composite material was prepared according to the same method as that in Example 1, except that the carbon fibers were not added in step S1.

### Comparative Example 2

### Preparation of the Carbon Nanotube Fly Ash Composite Material M10:

S1: river sand and cementitious material were blended by stirring at a rotation rate of 300 r/min for 2 min, carbon fibers were further added, water and an alkali activator were finally added, and the materials were stirred at a rotation rate of 400 r/min for 3 min, a fly ash compound slurry K1 was obtained; wherein the weight ratio of dosage of the river sand to the cementitious material was 1:4; the cementitious material contained fly ash in an amount of 70 wt % of fly ash, a slab in an amount of 20 wt %, and silica fume in an amount of 10 wt %; the weight ratio of the total weight of the river sand and the cementitious material to the carbon fibers was 100:0.5, the weight ratio of the total weight of the river sand and the cementitious material to the alkali activator was 100:35, the weight ratio of NaOH to sodium silicate in the alkali activator was 0.4:1;
S2: the fly ash compound slurry K1 obtained in step S1 was transferred into an electrode mold for curing at the temperature of 20° C. for 24 hours, then subjected to demolding and polishing to obtain a carbon nanotube fly ash composite material M10;

The second fabric electrode D1 was prepared according to the same method as that in Example 1;

A cotton fabric and the second fabric electrode D1 were laminated on the surface of the carbon nanotube fly ash composite material M10 in sequence, and assembled to form an asymmetric supercapacitor N10.

### Test Example

The energy density, power density, and the lighting time of bulb of the asymmetric supercapacitors prepared in Examples 1-9 and Comparative Examples 1-2 were tested respectively, wherein the lighting time of bulb was tested with the following method: the positive and negative electrodes of the asymmetric supercapacitor were connected with the positive and negative electrodes of a direct current power source respectively, the output voltage of the direct current power source was fixed at 120V, the asymmetric supercapacitor was charged until the output current of the direct current power source was constant, the asymmetric supercapacitor was then disconnected with the direct current power source, the positive and negative electrodes of the asymmetric supercapacitor were connected with the positive and negative electrodes of a bulb having a nominal power of 100 W, and the lighting time of said bulb was tested, the test results were shown in Table 1;

TABLE 1

| | Energy density | Power density | Lighting time of bulb |
|---|---|---|---|
| Number | (μWh/cm²) | (μW/cm²) | (min) |
| Example 1 | 179.62 | 11057.8 | 139.56 |
| Example 2 | 191.21 | 15427.8 | 185.14 |
| Example 3 | 199.75 | 21052.5 | 204.89 |
| Example 4 | 188.61 | 11610.6 | 146.63 |
| Example 5 | 196.95 | 12124.1 | 202.06 |
| Example 6 | 211.73 | 13034.2 | 238.12 |
| Example 7 | 284.13 | 23215.8 | 255.53 |
| Example 8 | 176.38 | 10722.06 | 137.11 |
| Example 9 | 168.65 | 10197.35 | 131.04 |
| Comparative | 161.66 | 9967.02 | 125.6 |
| Example 1 | | | |
| Comparative | 4.5 | 230.45 | 2.23 |
| Example 2 | | | |

As can be seen from the data in Table 1, the asymmetric supercapacitors prepared with the carbon nanotube fly ash composite material of the present disclosure have stable properties, high charge-discharge efficiency, and high energy density and power density, and can be utilized in the aspects of large-capacity energy storage such as dwelling, transportation and industrial application.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1. A carbon nanotube fly ash composite material, characterized in that the carbon nanotube fly ash composite material comprises an acidified carbon nanotube fiber fabric and a fly ash compound attached to the acidified carbon nanotube fiber fabric, wherein the fly ash compound comprises a cementitious material, a fine aggregate, an alkali activator, and carbon fibers, wherein the cementitious material is a mixture of fly ash, slag, and silica fume.

2. The carbon nanotube fly ash composite material of claim 1, wherein the acidified carbon nanotube fiber fabric is obtained by subjecting a carbon nanotube fiber fabric to heat treatment and acidification treatment in sequence.

3. The carbon nanotube fly ash composite material of claim 2, wherein the raw materials for preparing the carbon nanotube fiber fabric comprise a liquid state carbon-containing organic substance, an iron-containing organic salt, and a sulfur-containing organic substance.

4. The carbon nanotube fly ash composite material of claim 3, wherein, the weight ratio of dosage of the liquid state carbon-containing organic substance to the iron-containing organic salt is (410-450):1, wherein the liquid state carbon-containing organic substance is calculated in terms of carbon element, and the iron-containing organic salt is calculated in terms of the iron element; the weight ratio of dosage of the liquid state carbon-containing organic substance to the sulfur-containing organic substance is (210-250):1, wherein the liquid state carbon-containing organic substance is calculated in terms of carbon element, and the sulfur-containing organic substance is calculated in terms of sulfur element.

5. The carbon nanotube fly ash composite material of claim 1, wherein the cementitious material contains fly ash in an amount of 70-80 wt %, slag in an amount of 15-20 wt %, and silica fume in an amount of 5-10 wt %, based on the total weight of said cementitious material;
the fly ash is Grade I calcium ash, wherein the content of CaO is not less than 90 wt %;
the slag contains Al₂O₃ and SiO₂ in an amount of 50 wt % or more, the slag has a specific surface area within the range of 600-800 m²/kg, and the screen residue of 45 μm square-hole sieve being less than 1%;
the silica fume has a particle size within the range of 0.1-0.3 μm, and a specific surface area within the range of 15,000-30,000 m²/kg.

6. The carbon nanotube fly ash composite material of claim 1, wherein the fine aggregate has a particle size within the range of 1,500-2,300 μm.

7. The carbon nanotube fly ash composite material of claim 6, wherein the fine aggregate is river sand.

8. The carbon nanotube fly ash composite material of claim 1, wherein the weight ratio of the fine aggregate to the cementitious material in the fly ash compound is within the range of 1:(2-4).

9. The carbon nanotube fly ash composite material of claim 1, wherein the alkali activator is contained in the fly ash compound in an amount of 17.5-52.5 parts by weight, relative to 100 parts by weight of the total weight of the fine aggregate and the cementitious material.

10. The carbon nanotube fly ash composite material of claim 1, wherein the alkali activator is a mixture of a strong base and sodium silicate, and the weight ratio of the strong base to the sodium silicate in the alkali activator is within the range of (0.2-0.6):1.

11. The carbon nanotube fly ash composite material of claim 1, wherein the carbon fiber is contained in the fly ash compound in an amount of 0.5-1 part by weight, relative to 100 parts by weight of the total weight of the fine aggregate and the cementitious material.

12. The carbon nanotube fly ash composite material of claim 1, wherein the acidified carbon nanotube fiber fabric is present in an amount of 1-18 parts by weight, relative to 100 parts by weight of the total weight of the fine aggregate and the cementitious material.

13. A method for preparing the carbon nanotube fly ash composite material of claim 1, the method comprises the following steps:
S1: blending a fine aggregate, a cementitious material, carbon fibers, and an alkali activator to obtain a fly ash compound slurry;
S2: subjecting a carbon nanotube fiber fabric to heat treatment and acidification treatment in sequence to obtain an acidified carbon nanotube fiber fabric;
S3: soaking the acidified carbon nanotube fiber fabric obtained in step S2 in the fly ash compound slurry obtained in step S1, then transferring the obtained material into an electrode mold for curing, followed by demolding and polishing.

14. The method of claim 13, wherein the method further comprises preparing the carbon nanotube fiber fabric according to the following processes:
A1: mixing a liquid state carbon-containing organic substance, an iron-containing organic salt, and a sulfur-containing organic substance, roasting the mixture in an inert atmosphere to obtain a carbon nanotube aerogel, and then subjecting the carbon nanotube aerogel to a water bath to form carbon nanotube fibers;
A2: twisting the carbon nanotube fibers obtained in the process A1 into yarns, and then weaving the yarns into a carbon nanotube fiber fabric.

15. The method of claim 14, wherein the conditions of roasting in process A1 comprise: the temperature within the range of 350-450° C. and the time within the range of 45-75 min.

16. The method of claim 13, wherein the conditions of heat treatment in step S2 comprise: the temperature within the range of 380-420° C. and the time within the range of 45-75 min.

17. The method of claim 13, wherein the acidification treatment in step S2 is to mix the heat-treated carbon nanotube fiber fabric with an acidic solution, and the mixing conditions comprise the temperature within the range of 40-50° C. and the time within the range of 5.5-6.5 h.

18. An asymmetric supercapacitor comprising a first fabric electrode, a second fabric electrode, and a diaphragm disposed between the first fabric electrode and the second fabric electrode, characterized in that the first fabric electrode is the carbon nanotube fly ash composite material of claim 1.

19. The asymmetric supercapacitor of claim 18, wherein the second fabric electrode comprises a nickel cobaltate nanowire-loaded and nitrogen-doped carbon nanotube fiber fabric, and a fly ash compound attached to the nickel cobaltate nanowire-loaded and nitrogen-doped carbon nanotube fiber fabric.

20. The asymmetric supercapacitor of claim 19, wherein the second fabric electrode is prepared according to the following processes:
B1: blending dopamine hydrochloride, water, and nanotube fiber fabric, adjusting the pH of the solution to within a range of 8-11 to obtain a polydopamine-coated nanotube fiber fabric, and then roasting in a nitrogen atmosphere to obtain a fabric A;
B2: mixing fabric A, a nickel precursor solution, a cobalt precursor solution, and urea, then carrying out a hydrothermal reaction to obtain a fabric B, taking out the fabric B and carrying out thermal treatment, and then blending with a fly ash compound slurry, subsequently transferring the obtained material into an electrode mold for curing, followed by demolding and polishing.
